(19) United States
(12) Patent Application Publication
(10) Pub. No.: US 2014/0374446 A1
(43) Pub. Date: Dec. 25, 2014

(54) FIXING ELEMENT AND DISPENSER COMPRISING SUCH A BODY

(71) Applicants: Sébastien Michaux, Caudebec Les Elbeuf (FR); Bruno Stuart, Hauville (FR)

(72) Inventors: Sébastien Michaux, Caudebec Les Elbeuf (FR); Bruno Stuart, Hauville (FR)

(73) Assignee: APTAR FRANCE SAS, Le Neubourg (FR)

(21) Appl. No.: 14/117,113

(22) PCT Filed: May 21, 2012
(86) PCT No.: PCT/FR12/51128

§ 371 Date: Aug. 5, 2014

(30) Foreign Application Priority Data
May 23, 2011 (FR) 1154460

(51) Int. Cl. B67D 7/06

(52) U.S. Cl. CPC B05B 11/3049; B05B 11/3046; B05B 11/0008; F16L 23/003
USPC 222/182; 222/153.11; 222/522

(57) ABSTRACT

A fastener member (5) for engaging around a neck (11) of a reservoir (1), the fastener member (5) including fastener means (52) that are axially engageable around the neck (11) until a final fastened position is reached in which the member (5) is fastened firmly around the neck (11), the fastener member being characterized in that it further includes guide means (56) that are axially engageable around the neck (11) before the fastener means (52) are engaged around the neck (11), so as to make it easier to position the fastener means (52) relative to the neck (11).

The present invention relates to a fastener member, such as a covering hoop, for engaging around a neck of a reservoir. The fastener member includes fastener means that may be engaged axially around the neck until a final assembled position is reached in which the member is firmly and advantageously permanently fastened around the neck. Advantageous fields of application of the present invention are the fields of perfumery, cosmetics, and pharmacy.

In the prior art, for a long time fastener members have been known that comprise a ring that is engaged around the neck, and a locking hoop that is engaged around the ring so as to lock it on the neck. Mention may be made of documents WO 2011/015760 and EP 2 135 682 that describe fastener members of that type.

In the prior art, there also exist cosmetic or fragrance dispensers that comprise: a fluid reservoir defining a neck; a dispenser member, such as a pump or a valve, that is mounted in the neck of the reservoir; and a fastener member, such as a covering hoop, that is engaged around the neck of the reservoir. By way of example, the pump or the valve may be mounted in stationary, leaktight, and preferably permanent manner in the neck of the reservoir by means of a mounting ring that comes into engagement with the neck of the reservoir. By way of example, the mounting ring may be a crimping ring that is crimped both around the pump or the valve and around the neck of the reservoir. The crimping ring substantially matches the outer shape of the neck of the reservoir, which neck may be made with annular peripheral reinforcement, for example. In this configuration, the crimping ring includes a portion that folds inwards below the annular peripheral reinforcement, in such a manner as to form a shoulder that is directed downwards.

In this context, the fastener member, which is a covering hoop, is engaged around the neck of the reservoir, coming into direct contact with the crimping ring. Thus, there is no direct contact between the covering hoop and the neck of the reservoir, given that said neck is covered by the crimping ring. The covering hoop includes fastener means that, in the final fastened position, come into engagement below the shoulder formed by the annular reinforcement and the crimping ring. In other words, the fastener means of the covering hoop come to be snap-fastened below the shoulder of the crimping ring. In this way, the covering hoop is fastened firmly and permanently around the neck of the reservoir. The covering hoop may perform an esthetic function only, but it may also perform a technical function, axially guiding the pusher while it is being mounted on the pump or valve and once it has been mounted on the pump or valve, or indeed preventing the pusher from being removed. The covering hoop may also perform other technical functions.

In this context, it is not always easy to put the fastener member (covering hoop) on the neck of the reservoir in such a manner as to engage the fastener means around the neck, so as to come into engagement below the shoulder formed by the mounting ring. This is even more difficult when the fastener member presents a large diameter, often corresponding to the size of the reservoir. When the fastener member is large, it is difficult to center it axially on the neck of the reservoir as a result of poor visibility. As a result, the operation of fastening the fastener member on the reservoir is time consuming and tricky. Very often, this operation is performed manually.

An object of the present invention is to remedy the above-mentioned drawbacks of the prior art by defining a fastener member that more easily engages the fastener means with and around the neck, in such a manner as to accelerate the assembly operation. The fastener member applies more particularly, but not exclusively, to a dispenser having a dispenser member that is mounted on the reservoir by means of a mounting ring, e.g. of the crimping ring type.

To do this, the present invention provides a fastener member for engaging around a neck of a reservoir, the fastener member including fastener means that are axially engageable with and around the neck until a final fastened position is reached in which the member is fastened firmly around the neck, the fastener member being characterized in that it further includes guide means that are axially engageable around the neck before the fastener means are engaged around the neck, so as to make it easier to position the fastener member and/or the fastener means relative to the neck. Thus, the guide means serve to center the fastener member relative to the neck of the reservoir by coming into engagement around the neck before the fastener means are engaged around the neck. To do this, the guide means axially extend below the fastener means. The guide means and the fastener means are thus engaged around the neck sequentially: firstly the guide means are engaged around the neck, followed by the fastener means. The fastener means alone fasten the fastener member on the neck of the reservoir: nevertheless, the guide means may participate in fastening on the neck.

According to a very advantageous characteristic of the present invention, the guide means are deformed against the reservoir in the final fastened position. Thus, the guide means do not prevent the fastener means from reaching their final fastened position. From the moment when the guide means perform their axial positioning function of the fastener means around the neck, they may retract by deforming, e.g. against the reservoir. The deformation of the guide means can also participate in fastening the fastener member around the neck.

In a practical embodiment, the guide means comprise a plurality of deformable tabs that freely extend radially inwards towards the neck. Advantageously, each tab comprises a radial blade and an axial flange that is engageable around the neck. Deformation of the tab occurs at the radial blade, e.g. at the location where it is connected to the remainder of the fastener member.

In another practical aspect, the fastener means comprise a plurality of rigid fastener segments that are engageable with and around the neck. Advantageously, each fastener segment comprises a radial plate and an axial skirt engageable around the neck. Advantageously, at least one of the segments is provided with a fastener profile that is adapted to come into engagement below a shoulder that is formed around the neck. It should be observed that the shoulder is not necessarily formed by the neck: alternatively, it may be formed by a mounting ring that is engaged around the neck.

Thus, the guide means and the fastener means present an overall configuration that is substantially similar, except that the fastener segments are rigid, while the deformable tabs are flexible. By way of example, it is possible to provide three fastener segments that are separated by three deformable guide tabs. The axial flanges of the tabs are oriented downwards, while, in opposite manner, the axial skirts of the fastener segments are oriented upwards.

In another practical aspect of the present invention, the fastener member includes an outer bushing, the guide means comprising a plurality of deformable tabs that freely extend radially inwards from the bushing towards the neck, the fastener means comprising a plurality of rigid fastener segments that freely extend radially inwards from the bushing towards the neck. The deformable tabs and the rigid fastener segments may be arranged in alternating manner. The deformable tabs may include axial flanges that are oriented downwards, while the fastener segments may include axial skirts that are oriented upwards.

The invention also defines a fluid dispenser comprising: a fluid reservoir defining a neck; a dispenser member, such as a pump or a valve, that is mounted in the neck of the reservoir; and a fastener member, as defined above, that is engaged around the neck of the reservoir. Advantageously, the dispenser further comprises a mounting ring for mounting the dispenser member in the neck, the fastener member coming into engagement with the mounting ring. Preferably, the mounting ring forms a ring shoulder below which the fastener means are housed, the guide means being deformed against the reservoir in the final fastened position. This is the preferred embodiment of the present invention.

In a variant, the fastener member comes directly into engagement with the neck of the reservoir, the neck forming a neck shoulder below which the fastener means are housed, the guide means being deformed against the reservoir in the final fastened position. In this configuration, the fastener member may incorporate mounting means that make it possible to mount the dispenser member in the neck of the reservoir.

The spirit of the invention is to provide the fastener member with guide means that make it easier to position the fastener means relative to the neck of the reservoir. A very advantageous characteristic resides in the fact that the guide means are deformable and are deformed, advantageously against the reservoir, when the fastener means have reached their final fastened position around the neck. The retraction or the withdrawal of the guide means once they have performed their function is an advantageous characteristic, since it enables the fastener means to perform their fastening function without being hindered by the guide means.

The invention is described more fully below with reference to the accompanying drawings, which show an embodiment of the invention by way of non-limiting example.

In the figures:

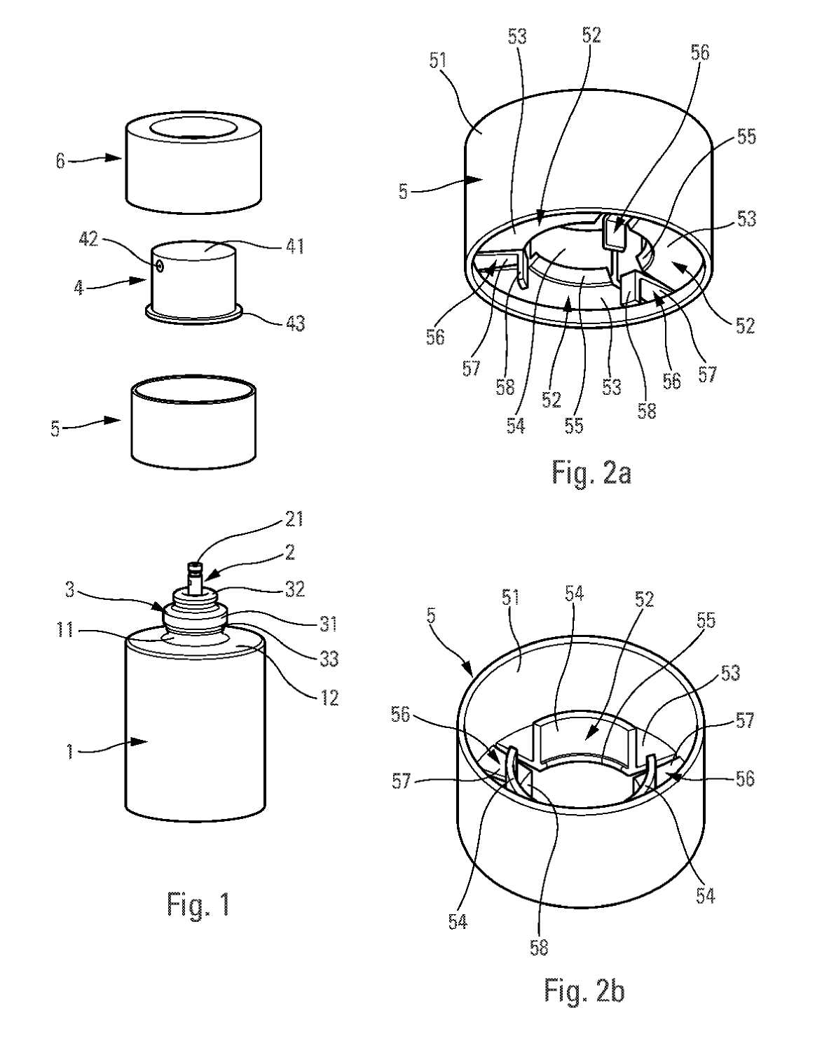

FIG. 1 is an exploded perspective view of a dispenser made in accordance with the invention;

FIGS. 2a and 2b are larger-scale perspective views, respectively from below and from above, of the fastener member made in accordance with a non-limiting embodiment of the invention;

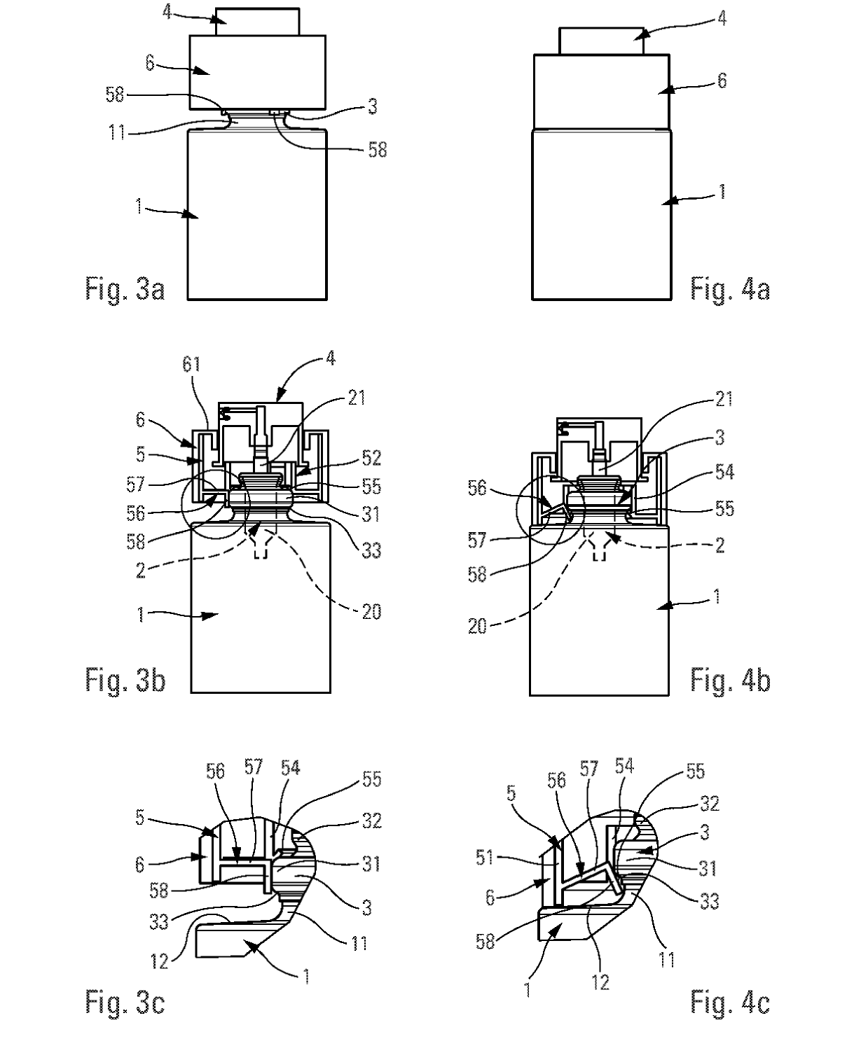

FIG. 3a is an elevation view of the dispenser during assembly, with the guide means engaged around the neck of the reservoir;

FIG. 3b is a section view similar to the view in FIG. 3a;

FIG. 3c is a large-scale view of a detail of FIG. 3b; and

FIGS. 4a, 4b, and 4c are views similar to FIGS. 3a, 3b, and 3c respectively, of the dispenser in its final fastened position.

Reference is made firstly to FIG. 1 for a general description of the various component elements of a fluid dispenser made in accordance with the invention. The dispenser comprises six component elements, namely: a fluid reservoir 1; a dispenser member 2; a mounting ring 3; a pusher 4; a fastener member 5; and a covering sheath 6.

The fluid reservoir 1 forms a neck 11 that extends upwards from a peripheral plate 12 that may be circular. The neck 11 may be made in conventional manner with annular peripheral reinforcement that projects outwards. The annular reinforcement traditionally serves to fasten a mounting ring for fastening the dispenser member in a neck of the reservoir.

The dispenser member 2 may be a pump or a valve that includes an actuator rod 21 that is axially movable down and up in a body 20, visible only in FIGS. 3b and 4b.

The function of the mounting ring 3 is to hold the dispenser member 2 firmly and advantageously in permanent manner in the neck 11 of the reservoir. In the particular embodiment shown in the figures, the mounting ring 3 is a crimping ring that is advantageously made of metal. The crimping ring 3 comprises a top portion 32 that is engaged around the body 20 of the dispenser member 2, and a bottom portion 31 that is engaged around the neck, and more particularly around the annular reinforcement of the neck. Thus, the bottom portion 31 forms a shoulder 33 that is directed downwards. This design is entirely conventional for a crimpable mounting ring. In a variant, it is possible that the crimping ring 3 does not include a top portion 32 surrounding a portion of the body 20 of the dispenser member 2.

The pusher 4 comes into engagement with the free end of the actuator rod 21 of the dispenser member 2, and further includes a bearing surface 41 and a dispenser orifice 42. The user may thus press by means of one or more fingers on the bearing surface 41, in such a manner as to drive the actuator rod 21 into the body 20 of the dispenser member. In response, fluid is dispensed through the dispenser orifice 42, optionally in metered manner. This design is entirely conventional also for a pusher in the fields of cosmetics, perfumery, and pharmacy. It should be observed that the pusher 4 forms a collar 43 that projects radially outwards at its bottom end.

Certain dispensers are limited to a reservoir, a dispenser member, a mounting ring, and a pusher. However, it is often desirable to adorn the dispenser with elements that are attractive or even functional. This is the situation with the fastener member 5 that may also be referred to as a covering hoop in the present embodiment. The fastener member 5 is associated with the covering sheath 6, and together they perform a function that is esthetic, but also technical. The covering sheath 6 is for engaging around the fastener member 5, as can be seen in FIGS. 3b and 4b. The covering sheath 6 includes an inwardly-directed rim 61 that extends over the collar 43 of the pusher 4, such that said pusher is held captive by the covering sheath 6 and cannot be removed from the actuator rod 21. This characteristic is optional: the collar 43 may be omitted.

The fastener member 5 is described below in greater detail with reference to FIGS. 2a and 2b. The fastener member 5 includes an outer bushing 51 of generally substantially circularly-cylindrical shape presenting a diameter that is a little less than the diameter of the reservoir 1. Inside the outer bushing 51, fastener means 52 and guide means 56 are formed.

The fastener means 52 are engageable with and axially around the neck 11, and more particularly with the mounting ring 3, until a final fastened position is reached in which they come into engagement below the shoulder 33 formed by the mounting ring 3. The final fastened position is a stationary and permanent position. In greater detail, the fastener means 52 comprise a plurality of fastener segments that extend inwards from the outer bushing 51. Each fastener segment comprises a radial plate 53 that is connected over its outer periphery to the inside of the outer bushing 51, and that is extended over its inner periphery by an axial skirt 54 that extends upwards. The axial skirts 54 co-operate with each other to form an interrupted cylinder. Each segment also comprises a fastener profile 55 that, by way of example, may be in the form of a sloping lip that is oriented upwards at the junction between the plate 53 and the skirt 54.

The guide means 56 comprise a plurality of deformable tabs 56 that extend inwards from the outer bushing 51. Each tab 56 comprises a radial blade 57 having one end that is connected to the outer bushing 51, and having the remote other end that is extended by an axial flange 58 that is oriented downwards. Advantageously, the radial blades 57 are flexible or bendable, in particular at their junction with the outer bushing 51. The guide tabs 56 are engageable around the neck of the reservoir, and more particularly around the mounting ring 3. In other words, the guide tabs 56 are engageable around the neck of the reservoir, and more particularly around the mounting ring 3.

With reference to FIGS. 2a and 2b, it should be observed that the fastener segments 52 occupy an angular extent that is much greater than the guide tabs 56. As a result, the fastener segments 52 are rigid, while the guide tabs 56 are flexible. It should also be observed that the fastener segments and the guide tabs are arranged in alternating manner: two segments are separated by one tab, and two tabs are separated by one segment. It should also be observed that the radial plates 53 extend substantially in the same plane as the radial blades 57. In addition, the axial skirts 54 extend substantially in the same cylinder as the axial flanges 58. In other words, the axial flanges 58 extend the axial skirts, but in the opposite direction, given that the axial skirts extend upwards, while the axial flanges extend downward. Advantageously, provision may be made for the axial flanges 58 to be offset a little towards the outside relative to the axial skirts 54. It should also be observed that the bottom free ends of the axial flanges 58 project downwards below the bottom end of the outer bushing 51, as can be observed in FIGS. 3a and 3b.

In the embodiment used to illustrate the present invention, the fastener member 5 comprises only an outer bushing 51, fastener means 52, and guide means 56. However, without going beyond the ambit of the invention, the fastener member 5 could also incorporate reception means for receiving the dispenser member 2. In that configuration, the dispenser would not include a mounting ring 3, the fastener means would come directly into engagement below the annular reinforcement of the neck, and the guide means would come to be engaged directly around the neck.

Reference is made below to FIGS. 3a to 4c in order to describe in detail an assembly operation for assembling a dispenser that incorporates a fastener member of the invention. In FIGS. 3a and 3b, it should be observed that the dispenser member 2 is already mounted in the neck of the reservoir by means of the mounting ring 3. The pusher has been pre-mounted in the assembly formed by the fastener member 5 and the covering sheath 6. The fastener member 5 is engaged around the mounting ring 3 in an intermediate assembly position. The guide means 56 are engaged around the neck, while the fastener means 52 are still arranged above the neck. More precisely, it can be seen that the axial flanges 58 are engaged around the bottom portion 31 of the mounting ring 3 that is crimped around the annular reinforcement formed by the neck 11. By means of the invention, it is particularly easy to achieve this intermediate assembly position, given that the axial flanges 58 project downwards below the outer bushing 51. This can be seen clearly in FIG. 3a. It should also be observed that the fastener profile 55 thus merely comes to bear on the bottom portion 31 of the mounting ring 3, as can be seen in FIG. 3c. It is not necessary for the axial flanges 58 to come into friction contact with the mounting ring 3. Clearance may exist between the flanges 58 and the bottom portion 31. In FIG. 3c, it should be observed that the deformable guide tabs are not deformed in this intermediate assembly position. Thus, the fastener member 5 is not subjected to any deformation stress. However, the pre-positioning of the fastener member 5 on the neck of the reservoir enables the correct axial positioning of the fastener means in view of their engagement around the neck. In addition, such pre-positioning makes it possible to guide the pusher 4 axially, in such a manner as to facilitate its engagement on the actuator rod 21.

It can easily be understood that by exerting sufficient axial force on the inwardly-directed rim 61 of the covering sheath 6, the fastener member 5 moves relative to the neck of the reservoir, in such a manner as to reach the final fastened position shown in FIGS. 4a to 4c. The axial force may be exerted simultaneously on the sheath 6 and on the pusher 4 so as to engage said pusher around the actuator rod 21. In FIG. 4a, it can be seen that the outer bushing 51 and/or the covering sheath 6 are in contact with the plate 12 of the reservoir 1, in such a manner as to form an intimate junction. Internally, it can be seen that the axial skirts 54 are held positioned around the bottom portion 33 of the mounting ring 3, with the fastener profiles 55 engaged below the shoulder 33. The engagement of the profiles 55 below the shoulder 33 form a firm and permanent snap-fastening. At the guide means 56, it should be observed that the resilient guide tabs have been deformed, since the radial blades 57 now point upwards. Deformation occurs at the junctions of the blades with the outer bushing 51. Deformation has been generated by the bottom free ends of the axial flanges 58 coming into bearing contact with the plate 12 of the reservoir. Given that the axial flanges 58 initially projected below the bottom edge of the bushing 51, the resilient guide tabs have been constrained to deform in order to bring the outer bushing 51 into contact with the plate 12. It can be said that once their guide function has been performed, the guide means 56 are withdrawn to the benefit of the fastener means 52 in order to bring them into the final fastened position. It can also be said that the deformable guide tabs 56 are retracted as the fastener segments 52 reach their final fastened positions. In this way, the guide means cannot hinder the fastener means in any way.

Although the fastener means come into contact with the bottom portion 31 of the mounting ring that is engaged around the neck, it can be considered that the fastener means come into contact with the neck. It is also possible to envisage mounting a fastener member of the invention directly on a reservoir neck that does not have a mounting ring: in this configuration, the fastener means come into direct contact with the neck. In any event, the guide means do not serve as an intermediate part for fastening the fastener means on the neck in the final fastened position. The guide means are not arranged or jammed between the fastener means and the neck of the reservoir in the final fastened position: they are positioned below the fastener means. The guide means do not co-operate with the fastener means in the final fastened position.

By means of the invention, it is possible to pre-mount or pre-position a fastener member on a reservoir neck very easily, with a view to fastening it permanently. The withdrawal or retraction of the guide means at the end of the fastening operation is an advantageous characteristic that does not generate any additional operation.

1-13. (canceled)

14. A fastener member for engaging around a neck of a reservoir, the fastener member including fastener means that are axially engageable with and around the neck until a final fastened position is reached in which the member is fastened firmly around the neck, the fastener member further including guide means that are axially engageable around the neck before the fastener means come into engagement with the neck, so as to make it easier to position the fastener member and the fastener means relative to the neck, the fastener member being characterized in that the guide means comprise a plurality of deformable tabs that freely extend radially inwards towards the neck.

15. A fastener ring according to claim 14, wherein the guide means axially extend below the fastener means, in particular in the final fastened position.

16. A fastener ring according to claim 14, wherein the guide means are deformed against the reservoir in the final fastened position.

17. A fastener ring according to claim 14, wherein each tab comprises a radial blade and an axial flange that is engageable around the neck.

18. A fastener member according to claim 14, wherein the fastener means comprise a plurality of rigid fastener segments that are engageable with and around the neck.

19. A fastener ring according to claim 18, wherein each fastener segment comprises a radial plate and an axial skirt engageable around the neck.

20. A fastener ring according to claim 18, wherein at least one of the segments is provided with a fastener profile that is adapted to come into engagement below a shoulder that is formed around the neck.

21. A fastener member according to claim 14, wherein the guide means and the fastener means are arranged in alternating manner around the neck.

22. A fastener member according to claim 14, including an outer bushing, the guide means comprising a plurality of deformable tabs that freely extend radially inwards from the bushing towards the neck, the fastener means comprising a plurality of rigid fastener segments that freely extend radially inwards from the bushing towards the neck.

23. A fluid dispenser comprising:
a fluid reservoir defining a neck;
a dispenser member, such as a pump or a valve, mounted in the neck of the reservoir; and
a fastener member according to any preceding claim, engaged around the neck of the reservoir.

24. A dispenser according to claim 23, further comprising a mounting ring for mounting the dispenser member in the neck, the fastener member coming into engagement with the mounting ring.

25. A dispenser according to claim 24, wherein the mounting ring forms a ring shoulder below which the fastener means are housed, the guide means being deformed against the reservoir in the final fastened position.

26. A dispenser according to claim 23, wherein the fastener member comes directly into engagement with the neck of the reservoir, the neck forming a neck shoulder below which the fastener means are housed, the guide means being deformed against the reservoir in the final fastened position.
